(19) United States
(12) Patent Application Publication
(10) Pub. No.: US 2021/0232472 A1
(43) Pub. Date: Jul. 29, 2021

(54) LOW-LATENCY SYSTEMS TO TRIGGER REMEDIAL ACTIONS IN DATA CENTERS BASED ON TELEMETRY DATA

(71) Applicant: HEWLETT PACKARD ENTERPRISE DEVELOPMENT LP, Houston, TX (US)

(72) Inventors: Venkatesh Nagaraj, Bangalore (IN); Mohan Parthasarathy, Bangalore (IN)

(21) Appl. No.: 16/773,390

(22) Filed: Jan. 27, 2020

(51) Int. Cl. G06F 11/30; G06F 9/48; G06F 9/50; G06N 20/00; G06K 9/62; H04L 12/26; H04L 12/28

(52) U.S. Cl. CPC G06F 11/3006; G06F 11/3024; G06F 11/3041; G06F 11/3058; H04L 12/28; G06F 9/5027; G06N 20/00; G06K 9/6256; H04L 43/0811; G06F 9/4881

(57) ABSTRACT

Systems and methods described herein reduce latency between the time at which telemetry data is collected in data center and the time at which a remedial action is triggered to address an event that can be predicted based on the telemetry data. Telemetry data is collected in a data center and used to create training data for a machine-learning model configured to predict events in the data center based on patterns in the telemetry data. The machine-learning model is stored at an edge appliance in the data center. Incoming telemetry data can be converted into an input instance that is input into the machine learning model. The machine-learning model generates an output score for the input instance. The output score provides information that indicates whether a remedial action should be taken in the data center to achieve a desired outcome. If a remedial action should be taken, the edge device sends a signal to trigger the remedial action within the data center.

### BACKGROUND

Edge appliances such as routers, switches, integrated access devices (IADs), and multiplexers generally serve as entry points for enterprise networks, service core provider networks, data center networks, or other types of networks. An embedded computer system, such as a computer-on-module (COM) or another type of single-board computer (SBC), can be included in an edge appliance to provide desired processing capability and other types of functionality.

Machine-learning models enable computing systems to generate without explicitly being programmed. Given a set of training data, a machine-learning model can generate and refine a function that predicts a target attribute for an instance based on other attributes of the instance.

A cloud computing system typically includes at least one data center and the physical computing resources contained therein, such as processors, memory, and storage. In addition, cloud computing systems offer virtualized computing resources (e.g., virtualized processing resources, storage resources, network resources, etc.) as a service to end users by implementing virtual resources on top of the physical resources.

### BRIEF DESCRIPTION OF THE DRAWINGS

Various features and advantages will become apparent from the following description, given by way of example only, which is made with reference to the accompanying drawings, of which:

FIG. 1 illustrates a first example computing environment 100 in which systems described herein can operate, according to one example.

FIG. 2 illustrates an example sequence of electronic communications and function executions performed in the computing environment shown in FIG. 1, according to one example.

FIG. 3 illustrates a second example computing environment in which systems described herein can operate, according to one example.

FIG. 4 illustrates an example sequence of electronic communications and function executions performed in the computing environment shown in FIG. 3, according to one example.

FIG. 5 illustrates functionality for a system as described herein, according to one example.

### DETAILED DESCRIPTION

A modern data center may include tens of thousands of servers (e.g., rack servers or blade servers) and many other types of electronic components, such as storage devices and network switches. Computing resources such as processors and memory may be networked together for rapid communication within the data center.

The environment within a data center poses a number of ongoing challenges. For example, when tens of thousands of servers packed closely together in racks are operating simultaneously, a great deal of heat is produced. If systems for cooling and ventilation are not functioning properly, sensitive electronic components may overheat very quickly. Similarly, if systems for delivering power to the servers malfunction (e.g., due to a power surge or a power outage), a great deal of damage can be done in a short amount of time. Even if the electronic components themselves are not damaged, valuable data may be lost if emergency power systems do not activate quickly enough. In addition, if a malware infection (e.g., ransomware) in one of the servers is not detected and quarantined rapidly, the malware may spread throughout the data center and inflict costly damage.

One approach for detecting potential problems in a data center is to collect telemetry data over time, correlate the telemetry data with different types of events that occur in the data center, and train a machine-learning model to predict when those events are about to occur in a data center.

However, the proposition of developing a machine-learning model that can predict different types of events in a large data center also poses a number of challenges. For example, tens of thousands of servers (and associated sensors) can collectively produce a very large amount of telemetry data in a short amount of time. This large amount of telemetry data is converted into a large amount training data that may be difficult to store in one place. Furthermore, many processors may have to work together to train the machine-learning model in an acceptable amount of time due to the sheer volume of the training data. If the data center is designed to provide services other than the analysis of its own telemetry data, the performance of those services may suffer if the too much of data center's resources are diverted to train a machine-learning model and store training data.

One possible solution is to send the telemetry data to an external cloud computing system that is specifically dedicated to providing analytics service and can therefore dynamically allocate a sufficient number of processing resources and the memory resources to train the machine-learning model. Given the amount of training data involved, this solution will likely produce a machine-learning model that performs well in terms of prediction accuracy. However, this solution also has drawbacks. For example, if the machine-learning model is stored in the cloud at a location that is remote relative to the data center, network congestion may slow the rate at which remote requests for event predictions can be received and answered. In the context of data centers, even a delay of a few seconds may cause a response that specifies a predicted event to arrive after the event has already commenced. In this scenario, the delay may be very costly. Hence, any reduction in latency would be very valuable.

Systems and methods described reduce the delay between the time at which telemetry data is collected and the time at which remedial action can be triggered in response to an event that can be predicted based on a pattern that a machine-learning model can detect in the telemetry data. By leveraging a machine-learning model stored at an edge appliance, systems described herein significantly reduce the network distance between the source of telemetry data and the location at which the telemetry data is analyzed for event detection. Furthermore, a hardware accelerator that is dedicated to performing the predictive function of the machine-learning model can be used to ensure that the predictive functionality will not be delayed due to competition with other functions performed by the edge appliance for processing resources and memory resources. In addition, systems described herein can also leverage cloud resources to update the machine-learning model without overextending the computing resources available at the edge appliance.

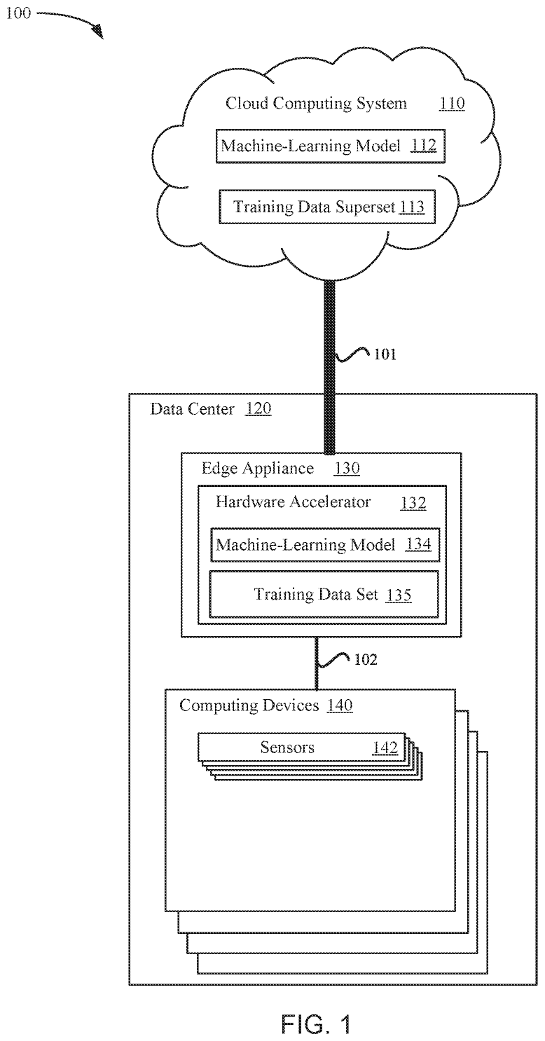

FIG. 1 illustrates a first example computing environment 100 in which systems described herein can operate, according to one example. As shown, the computing environment 100 may include a data center 120. Within the data center 120, the computing devices 140 may be communicatively connected to each other and to the edge appliance 130 via a connection 102 of a first network (e.g., a data center network (DCN) or an enterprise network). In examples where the first network is a DCN, many network topologies may be used without departing from the spirit and scope of this disclosure. For example, topologies such as Fat-Tree, Leaf-Spine, VL2, JellyFish, DCell, BCube, and Xpander may all be used.

The edge appliance 130 may also be communicatively connected to the cloud computing system 110 via a connection 101 of a second network (e.g., a wide-area network (WAN)). In one example, the edge appliance 130 serves as a gateway that controls network traffic between the cloud computing system 110 and the computing devices 140 (e.g., servers) in the data center 120.

In one example, the cloud computing system 110 may provide machine-learning-based analytics as a service for the data center 120 so that the majority of the computing resources in the data center 120 can be devoted to other purposes. For example, the data center 120 itself may serve as a cloud computing system that provides services to other entities. Collectively, the cloud computing system 110 and the data center 120 may be part of a hybrid cloud environment.

The computing devices 140 are associated with sensors 142 in the data center 120. The sensors 142 may include hardware sensors such as voltage sensors, current (e.g., amperage) sensors, moisture sensors, thermal sensors (e.g., thermistors, thermocouples, or resistance temperature detectors (RTDs)), audio sensors (e.g., microphones), motion detectors, or other types of hardware sensors. In addition, the sensors 142 may include software modules such as computer programs (e.g., task managers) that measure an extent to which a computing resource is being used. For example, a software performance analysis module may measure levels of central-processing-unit (CPU) utilization, memory utilization, input/output (I/O) utilization, network utilization, or other quantities of interest (e.g., storage utilization).

The sensors 142 take sensor readings that measure one or more properties of interest over time and report those sensor readings (e.g., individually or in batches) to the computing devices 140 or directly to the edge appliance 130 (e.g., via the connection 102 of the first network). The sensors 142 may be configured to report the sensor readings automatically at a predefined frequency or reactively in response to queries from the computing devices 140 or the edge appliance 130. In cases where some of the sensors 142 report sensor readings to the computing devices 140 rather than directly to the edge appliance 130, the computing devices 140 may forward the reported sensor readings to the edge appliance 130 as raw data or as processed data that is derived therefrom by applying one or more preprocessing steps (e.g., normalizing, discretizing, aggregating, averaging, etc.). Raw sensor readings from the sensors 142, preprocessed sensor data derived therefrom, or any combination thereof will be referred to herein as telemetry data.

In addition, the computing devices 140 may send reports of timestamped events related to the telemetry data to the edge appliance 130. For example, thermal events are related to telemetry data from thermal sensors. If a processor in one of the computing devices 140 reaches a temperature that exceeds a predefined threshold, the computing devices 140 may send a message to the edge appliance 130. The message comprises an indication of the event type (e.g., overheating), the affected components (e.g., the processor), and the timestamp at which the event occurred. Many other types of events (e.g., utilization of a particular computing resource exceeding a threshold, power failure, etc.) may be reported to the edge appliance 130 in a similar fashion.

The edge appliance 130 includes a hardware accelerator 132. As used herein, the term “hardware accelerator” refers to one or more specialized hardware device(s) such as one or more graphics processing unit (GPUs), field-programmable gate array (FPGAs), application-specific integrated circuits (ASICs), or memristor crossbar arrays. In addition, a machine-learning model 134 is stored in memory that is accessible to the hardware accelerator 132 locally within the edge appliance 130.

The machine-learning model 134 defines a function that receives a set of input values (i.e., actual parameters) for a set of attributes (i.e., the formal parameters to which the actual parameters map) as input and, based on those values, generates an output score for that set of input values. In one example, the machine-learning model 134 is pre-trained beforehand in factory (e.g., where the hardware accelerator 132 is produced) so that it can be used for predictive purposes immediately upon installation.

In different examples, the meaning that the output score is meant to convey can vary. In one example, the output score may represent a remedial action to be taken in the data center 120 to alleviate a suboptimal condition in the data center 120 that is evidenced by the set of values or to reduce the probability that an undesirable event will occur within the data center 120 within a certain period of time (e.g., labels such as “no action,” “redistribute workload,” “shutdown,” “activate air conditioner,” “defragment storage volumes,” “reboot,” etc. may be possible outcome score values). In another example, the output score may represent a probability that a certain type of event is likely to occur in the data center 120 or one of the computing devices 140 within a certain period of time. Hence, the output score may be quantitative (continuous or discrete) or categorical.

However, regardless of the exact meaning of the output score, the output score provides information that indicates whether a remedial action of some kind should be taken in the data center 120 to achieve a desired outcome. In some examples, the output score directly identifies the remedial action to be taken. In other examples, the output score simply provides a probability of a certain type of event or some other value that quantifies a state of the data center 120. In either case, though, the remedial action to be taken can be ascertained by determining whether the output score meets some predefined condition. For example, if the output score equals “redistribute workload,” the remedial action could be redistributing the workload via a scheduler. In another example, if the output score is greater than 0.25 (or some other threshold value), the remedial action may involve redistributing a workload amongst the computing devices 140 via the scheduler. Persons of skill in the art will recognize that these examples are merely illustrative.

Upon receiving telemetry data from the computing devices 140 or directly from the sensors 142, the hardware accelerator 132 generates training data (training data set 135) for the machine-learning model 134 based on the telemetry data. This training data set 135 is stored in memory at the edge appliance 130 that is accessible to the hardware accelerator 132. In one example, the training data set 135 comprises a set of training instances. A training instance includes a single set of values (e.g., actual parameters) that the machine-learning model 134 receives as input. In response to receiving the set of values as input, the machine-learning model 134 generates a predicted output score based on those values. The training instance also includes a target output score. The target output score has verified, a posteriori, to be “correct” (e.g., verified through observation to achieve the outcome in the data center 120 or manually supplied by an administrator with domain expertise).

Persons of skill in the art will recognize that training data may be stored in a variety of ways. For example, training instances may be stored as tuples in a table of a database. In another example, training data may be stored in an Attribute Relation File Format (ARFF) file. In this example, the attributes (e.g., formal parameters) are listed in a header section. In the header section, the text “@ATTRIBUTE” (generally case insensitive) appears at the beginning of each line that specifies the name of an attribute and the range of possible values for that attribute. The text “@DATA” (generally case insensitive) marks the beginning of a section where the training instances are stored. Each training instance is stored on a single line and includes the set of values (e.g., actual parameters) and the target output score that make up the respective training instance. The values and the target output score are delimited by commas. In other examples, training instances may be stored in other formats or data structures.

Since the target outputs are known for training instances, the accuracy of the machine-learning model 134 for a given training instance can be measured by comparing the target output score to the predicted output score. For example, if output scores generated by the machine-learning model 134 are numeric, the numerical difference between the target output score and the predicted output score can be considered the error amount for the training instance. In another example, if the output scores generated by the machine-learning model 134 are categorical, the prediction accuracy of the machine-learning model 134 for the training instance may be a Boolean determination of whether the predicted output score matches the target output score. In either case, the error the machine-learning model 134 commits on each training instance in a set of training data is used to determine how to tune the machine-learning model 134 to achieve better accuracy overall for that set of training data. Persons of skill in the art will understand that a full discussion of training techniques for machine-learning models is beyond the scope of this disclosure.

Once the machine-learning model 134 has been trained sufficiently to achieve a desired level of accuracy on a set of training data, the machine-learning model 134 can be used to generate predicted output scores in real time for instances (e.g., sets of values) for which target output scores are not yet available. When the hardware accelerator 132 receives current telemetry data from the computing devices 140 or the sensors 142 in real time, the hardware accelerator 132 can convert the telemetry data into a current input instance for the machine-learning model 134. As used herein, the term “current input instance” refers to a set of values for which an output score is currently sought (e.g., for the purpose of identifying a remedial action to apply presently in the data center 120 to achieve a desired outcome). Next, the hardware accelerator 132 inputs the current input instance into the machine-learning model 134. In response, the machine-learning model 134 generates an output score based on the current input instance.

As explained above, an output score provides information that indicates whether a remedial action of some kind should be taken in the data center 120 to achieve a desired outcome. Thus, once the machine-learning model 134 generates that output score, the hardware accelerator 132 can immediately use the output score to trigger a remedial action indicated thereby in the data center 120 with very little latency. For example, if the remedial action is to be executed within the edge appliance 130, a signal that initiates the remedial action may travel from the hardware accelerator 132 to a central processing unit (CPU) of the edge appliance 130 via a high-speed bus without having to traverse any network connections. In another example, suppose the remedial action is to be executed on one of the computing devices 140. The signal to initiate the remedial action can travel directly from the edge appliance 130 to the computing devices 140 via the connection 102 of the first network because with very little latency because the data transfer rate of the first network is high (e.g., relative to data transfer rates of WANs) and because the geographical distance between the edge appliance 130 and the computing devices 140 is small (e.g., typically no more than 200 meters).

Thus, when the machine-learning model 134 is stored locally in the edge appliance 130, the machine-learning model 134 can be leveraged to trigger remedial actions very quickly in response to potentially problematic events within the data center 120. In addition, as updated telemetry data from the computing devices 140 and the sensors 142 is received at the edge appliance 130 in a feedback loop, the hardware accelerator 132 generates corresponding updated training data and adds the updated training data to the training data set 135. The machine-learning model 134 can be continuously refined over time as the machine-learning model 134 is retrained periodically using the training data set 135 after such updates.

Further advantages can be achieved through leveraging the cloud computing system 110 in combination with the edge appliance 130 in the manner described below.

Like the machine-learning model 134, the machine-learning model 112 defines a function can receive an input instance and, based the values that make up the input instance, generate a corresponding output score. However, because the machine-learning model 112 is stored in memory in the cloud computing system 110, the machine-learning model 112 is stored in a location that is remote relative to the data center 120. There may be relatively high latency for electronic communications between the data center 120 and cloud computing system 110 due to the geographic distance between the data center 120 and due to the relatively low data transfer rate for the connection 101 of the WAN. For this reason, it is generally preferable to use the machine-learning model 134 rather than the machine-learning model 112 to detect when to apply remedial actions in the data center 120.

Nevertheless, the machine-learning model 112 can be used in the following manner to enhance the performance of the machine-learning model 134. First, the edge appliance 130 can be configured to transmit the training data set 135 to the cloud computing system 110 for storage in the training data superset 113 (which is stored in memory or storage resources included in the cloud computing system 110). When the training data set 135 is updated at the edge appliance 130, the edge appliance 130 also sends a message to update the training data superset 113. In some examples, once the machine-learning model 134 is retrained after the training data set has been updated, some or all of the training data set 135 that has been sent to the training data superset 113 may be deleted to free up memory space at the edge appliance 130.

The training data superset 113 may also include training data submitted to the cloud computing system 110 from other data centers (not shown). Since the cloud computing system 110 may include vast memory and storage resources that are spread across multiple locations, the size of the training data superset 113 is much less constrained than the size of the training data set 135 (which may be constrained by the amount of memory available in the edge appliance). In addition, since the cloud computing system 110 includes many processors, the cloud computing system 110 can use the training data superset 113 to train the machine-learning model 112 even if the size of the training data superset 113 is very large and even if many processors have to be used to complete the training in a reasonable amount of time. Thus, the machine-learning model 112 can be trained using a much broader set of training data than could be stored at the edge appliance 130. One result is that the machine-learning model 112 can become much more refined and accurate than a model trained using the training data set 135 alone.

Once the machine-learning model 112 is trained, the cloud computing system 110 can transmit the machine-learning model 112 to the edge appliance 130 along with a timestamp indicating which version of the training data set 135 was included in the training data superset 113 when the machine-learning model 112 was trained. When an updated version of the machine-learning model 112 is received, the hardware accelerator can update the machine-learning model 134 to be a copy of the updated machine-learning model 112. Furthermore, if any new training instances have been added to the training data set 135 recently (e.g., after the timestamp), the hardware accelerator 132 can further train the updated machine-learning model 134 using the new training instances.

In this manner, the machine-learning model 134 says up-to-date with respect to both the training data set 135 and the training data superset 113 even though the training data superset 113 may be too large for the hardware accelerator 132 to train the machine-learning model 134 locally using the entire training data superset 113. Since the machine-learning model 134 is stored at the edge appliance 130, remedial actions are still triggered in the data center with very low latency.

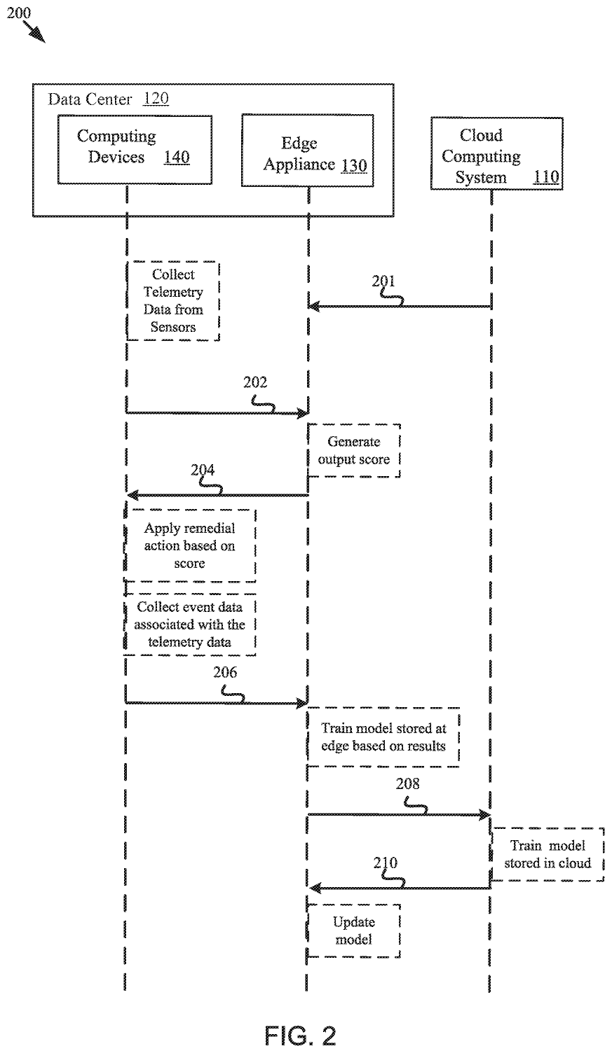

FIG. 2 illustrates an example sequence of electronic communications and function executions performed in the computing environment 100 shown in FIG. 1, according to one example.

At arrow 201, the cloud computing system 110 transmits the machine-learning model 112 to the edge appliance 130. In the meantime, the computing devices 140 collect telemetry data from the sensors 142.

At arrow 202, the computing devices 140 transmit the telemetry data to the edge appliance 130. Upon receiving the telemetry data, the edge appliance 130 converts the telemetry data into a current input instance and generates a predicted output score for the current input instance via the machine-learning model 134.

At arrow 204, the edge appliance 130 transmits a signal to the computing devices 140 to trigger a remedial action indicated by the predicted output score. The computing devices 140 apply the remedial action, then collect event data associated with the telemetry data. The event data indicates whether applying the remedial action achieved the desired result.

At arrow 206, the computing devices 140 transmit the event data to the edge appliance 130. Based on the event data, the edge appliance 130 verifies whether the predicted output score was correct (e.g., indicated a remedial action that achieved a desired outcome). Next, the edge appliance 130 creates a new training instance that includes the data values of the current input instance and the correct outcome score and trains the machine-learning model 112 using the new training instance.

At arrow 208, the edge appliance 130 transmits the new training instance to the cloud computing system 110. The cloud computing system 110 adds the new training instance to the training data superset 113, then updates the machine-learning model 112 via training with the updated training data superset 113.

At arrow 210, the cloud computing system 110 transmits the updated machine-learning model 112 to the edge appliance 130. The edge appliance 130 updates the machine-learning model 134 to match the updated machine-learning model 112.

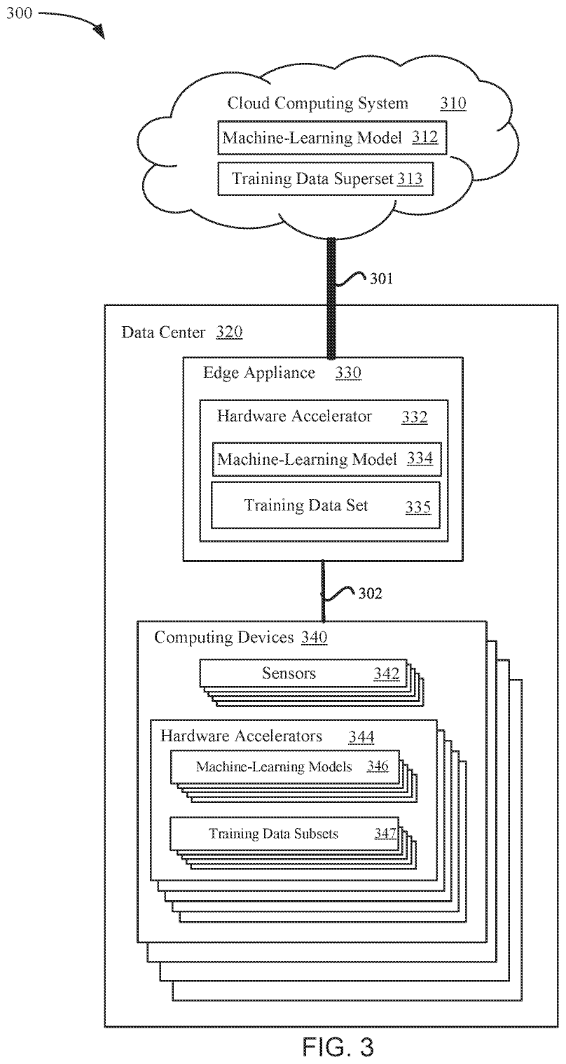

FIG. 3 illustrates a second example computing environment 300 in which systems described herein can operate, according to one example. As shown, the computing environment 300 may include a data center 320. Within the data center 320, the computing devices 340 may be communicatively connected to each other and to the edge appliance 330 via a connection 302 of a DCN. The edge appliance 330 may also be communicatively connected to the cloud computing system 310 via a connection 301 of a WAN. In one example, the edge appliance 330 serves as a gateway that controls network traffic between the cloud computing system 310 and the computing devices 340 (e.g., servers or, in some cases, endpoint devices such as desktop computers) in the data center 320.

The computing devices 340 are associated with sensors 342 in the data center 320. The sensors 342 may include hardware sensors or software modules such that measure an extent to which a computing resource is being used.

The sensors 342 take sensor readings that measure one or more properties of interest over time and report those sensor readings (e.g., individually or in batches) to the computing devices 340 or, in some cases, directly to the edge appliance 330 (e.g., via the connection 102 of the DCN). The sensors 342 may be configured to report the sensor readings automatically at a predefined frequency or reactively in response to queries from the computing devices 340 or the edge appliance 330. In one example, each of the sensors 342 reports one of the computing devices 340. In this example, each individual device of the computing devices 340 receives reports from a respective subset of the sensors 342 that are associated with that individual device.

The computing devices 140 track timestamped events related to the telemetry data (e.g., the sensor readings or preprocessed derivatives thereof). For example, thermal events are related to telemetry data from thermal sensors. If a processor in one of the computing devices 140 reaches a temperature that exceeds a predefined threshold, the event type (e.g., overheating), the affected components (e.g., the processor), and the timestamp at which the event occurred are recorded. Many other types of events (e.g., utilization of a particular computing resource exceeding a threshold, power failure, etc.) may also be recorded in a similar fashion.

Each of the computing devices 340 includes one of the hardware accelerators 344, respectively. In addition, each of the hardware accelerators 332 can access a respective one of the machine-learning models 346 in local memory. Each of the machine-learning models 346 defines a function that receives a set of values as an input instance and generates an output score for those input values.

As explained above with respect to FIG. 1, the meaning that the output score is meant to convey can vary, but the output score provides information that indicates whether a remedial action should be taken in the data center 320 to achieve a desired outcome.

Upon receiving telemetry data from the sensors 342, the hardware accelerators 344 generate the training data subsets 347 for the machine-learning models 346 based on the telemetry data. This training data subsets 347 are stored locally at the computing devices 340 in memory that is accessible to the hardware accelerators 344. In one example, the training data subsets 347 comprise training instances. The computing devices 340 also transmit the training data subsets 347 to the hardware accelerator 332 of the edge appliance 330 via the connection 302 of the DCN.

Upon receiving the training data subsets 347, the hardware accelerator 332 compiles the training data subsets 347 into the training data set 335. In addition, the edge appliance 330 transmits the training data set 335 to the cloud computing system 310 via the connection 301 of the WAN. The cloud computing system 310 adds the training data set to the training data superset 313, which includes training data received from additional data centers (not shown).

The cloud computing system 310 uses the training data superset 313 to train the machine-learning model 312. After the machine-learning model 312 is trained, the cloud computing system 310 transmits the machine-learning model 312 to the edge appliance 330. The hardware accelerator 332 first updates the machine-learning model 334 to match the machine-learning model 312, then trains the machine-learning model 334 using any training instances in the training data set 335 that were created after the last time the edge appliance 330 transmitted the training data set 335 to the cloud computing system 310.

Once the machine-learning model 334 is trained, the edge appliance 330 transmits the machine-learning model 334 to the computing devices 340. Each of the computing devices 340 includes one of the hardware accelerators 344, respectively. Each of the hardware accelerators 344 updates a respective one of the machine-learning models 346 to match the machine-learning model 334, then trains that one of the machine-learning models 346 using a respective one of the training data subsets 347.

Once the machine-learning models 346 have been trained, each of the machine-learning models 346 can be used to generate predicted output scores in real time for input instances. When a one of the hardware accelerators 344 receives current telemetry data from the sensors 342, a corresponding one of the hardware accelerators 344 converts the telemetry data into a current input instance. The current input instance is then input into a corresponding one of the machine-learning models 346. An output score is generated thereby based on the current input instance.

If the output score indicates that a remedial action should be taken, the remedial action can be triggered immediately without very little latency. For example, if the remedial action is to be executed on the same one of the computing devices 340 in which the output score was determined, a signal to trigger the remedial action may be able to travel from the signal source (e.g., one of the hardware accelerators 344) to signal destination without even using the first network of the data center 320.

Thus, when the machine-learning models 346 are stored locally in the computing devices 340, the machine-learning models 346 can be leveraged to trigger remedial actions very quickly in response to potentially problematic events within the data center 120. In addition, as updated telemetry data from the sensors 342 is received at the computing devices 340 in a feedback loop, the hardware accelerators 344 can add new training instances to the training data subsets 347, retrain the machine-learning models 346, and transmit the new training instances to the edge appliance 330. The edge appliance 330 can add the new training instances to the training data set 335, retrain the machine-learning model 334, and send the updated machine-learning model 334 to the computing devices 349. Also, the edge appliance 330 transmits the new training instances to the cloud computing system 310. The cloud computing system 310 adds the new training instances to the training data superset 313 and retrains the machine-learning model 312. The pattern described above for updating the machine-learning model 312, the machine-learning model 334, and the machine-learning models 346 can begin another iteration when the cloud computing system 310 transmits the updated machine-learning model 312 to the edge appliance 330.

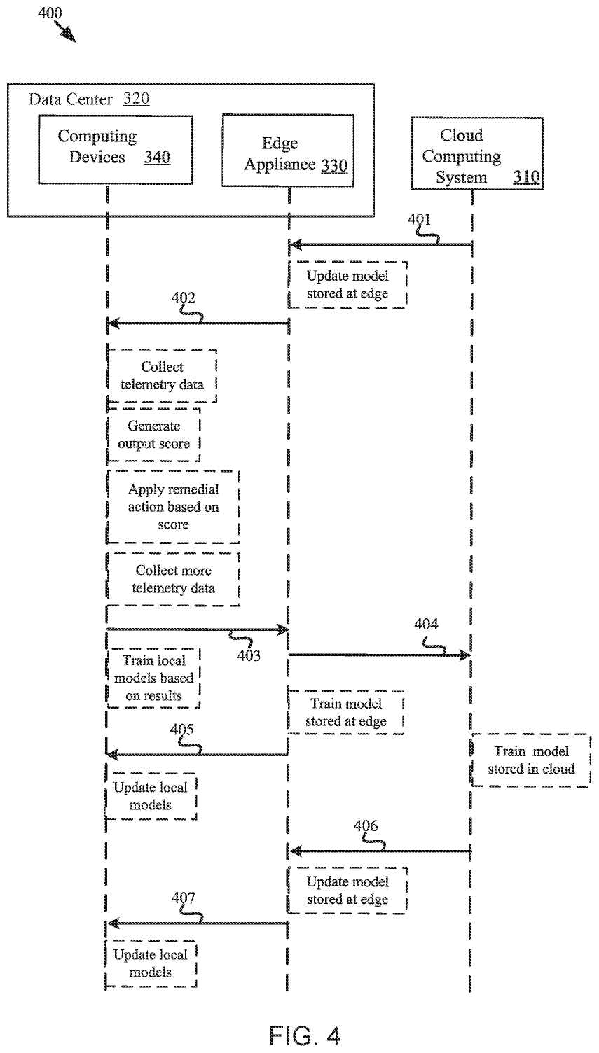

FIG. 4 illustrates an example sequence of electronic communications and function executions performed in the computing environment 300 shown in FIG. 3, according to one example.

At arrow 401, the cloud computing system 310 transmits the machine-learning model 312 to the edge appliance 330. The edge appliance 330 updates the machine-learning model 334 to match the machine-learning model 312.

Next, at arrow 402, the edge appliance 330 transmits the machine-learning model 334 to the computing devices 340. The computing devices 340 update the machine-learning models 346 to match the machine-learning model 334. In the meantime, the computing devices 340 collect telemetry data from the sensors 342.

Upon receiving the telemetry data from each respective subset of the sensors 342, each of the computing devices 340 converts the telemetry data received into a respective current input instance and generates a respective predicted output score for the respective current input instance via a respective one of the machine-learning models 346. Each of the computing devices applies a remedial action indicated by the respective predicted output score, then collects event data associated with the telemetry data to verify whether applying the remedial action achieved a respective desired result. Based on the event data, the each of the computing devices 340 determines whether the respective predicted output score was correct (e.g., indicated a remedial action that achieved a desired outcome). Next, each of the computing devices 340 creates a new respective training instance that includes the data values of the respective current input instance and the respective correct outcome score. Each of the computing devices 340 then trains the respective one of the machine-learning models 346 using the new respective training instance and adds the new respective training instance to a respective one of the training data subsets 347.

At arrow 403, each of the computing devices 340 transmits the new respective training instance to the edge appliance 330. In addition, at arrow 404, the edge appliance 330 transmits the new respective training instances to the cloud computing system 310. The edge appliance 330 adds the new respective training instances to the training data set 335, then updates the machine-learning model 334 via training with the updated training data set 335.

At arrow 405, the edge appliance 330 sends the updated machine-learning model 334 to the computing devices 340. Each of the computing devices 340 updates a respective one of the machine-learning models 346 to match the updated machine-learning model 334. In the meantime, the cloud computing system 310 adds the new respective training instances to the training data superset 313. In addition, the cloud computing system 310 adds training instances from other data centers (not shown) to the training data superset 313. Next, the cloud computing system 310 updates the machine-learning model 312 via training with the updated training data superset 313.

At arrow 406, the cloud computing system 310 transmits the updated machine-learning model 312 to the edge appliance 330. The edge appliance 330 updates the machine-learning model 334 to match the updated machine-learning model 312.

At arrow 407, the edge appliance 330 sends the updated machine-learning model 312 to the computing devices 340. The computing devices 340 then update the machine-learning models 346 to match the updated machine-learning model 312.

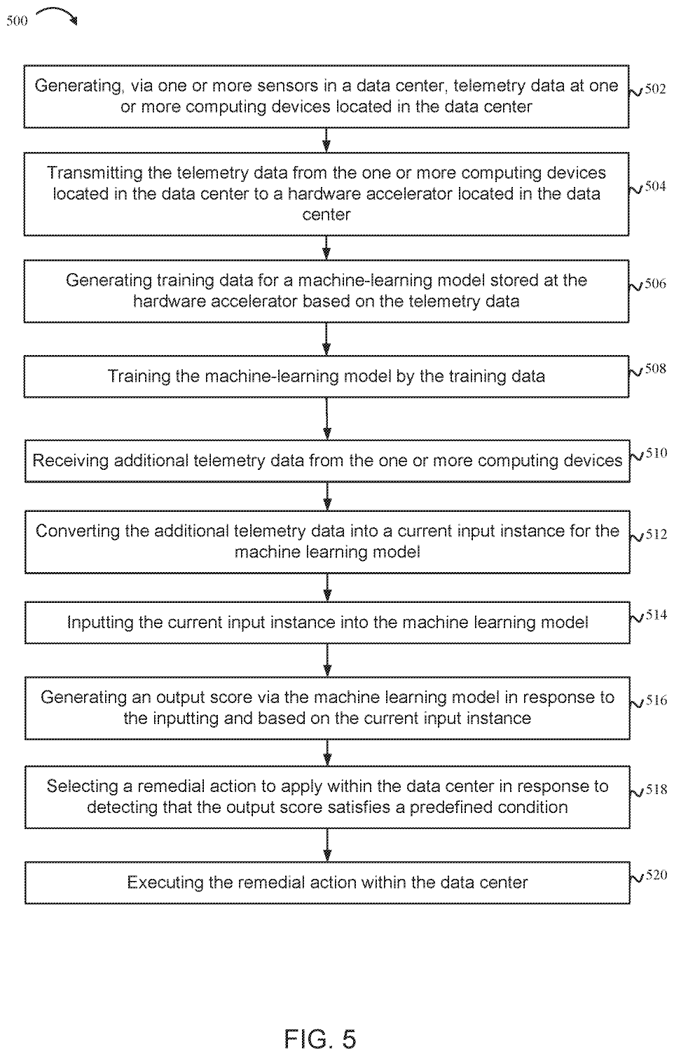

FIG. 5 illustrates functionality 500 for a system as described herein, according to one example. The functionality 500 may be implemented as a method or can be executed as instructions on a machine (e.g., by one or more processors), where the instructions are included on at least one computer-readable storage medium (e.g., a transitory or non-transitory computer-readable storage medium). While only ten blocks are shown in the functionality 500, the functionality 500 may include other actions described herein. Also, some of the blocks shown in the functionality 500 may be omitted without departing from the spirit and scope of this disclosure.

As shown in block 502, the functionality 500 includes generating, via one or more sensors in a data center, telemetry data at one or more computing devices located in the data center. The telemetry data may comprise a CPU utilization level, an I/O utilization level, a network utilization level, sensor data from a temperature sensor, or sensor data from a voltage sensor. As used herein, the word “or” indicates an inclusive disjunction.

As shown in block 504, the functionality 500 includes transmitting the telemetry data from the one or more computing devices located in the data center to a hardware accelerator located in the data center. The hardware accelerator may be located in an edge appliance that is connected to a first network or in a chassis that houses at least one of the one or more computing devices. The one or more computing devices located in the data center may also be connected to the DCN. The hardware accelerator may be a GPU.

As shown in block 506, the functionality 500 includes generating training data for a machine-learning model stored at the hardware accelerator based on the telemetry data. The functionality 500 may also include transmitting the training data to a cloud computing system that is located outside of the data center. Furthermore, the functionality 500 may include receiving an updated machine-model from the cloud computing system and storing the updated machine-learning model at the hardware accelerator.

As shown in block 508, the functionality 500 includes training the machine-learning model based on the training data. The functionality 500 may also include transmitting the machine-learning model to an additional hardware accelerator that is located in a chassis that houses at least one of the one or more computing devices.

As shown in block 510, the functionality 500 includes receiving additional telemetry data from the one or more computing devices.

As shown in block 512, the functionality 500 includes converting the additional telemetry data into a current input instance for the machine learning model.

As shown in block 514, the functionality 500 includes inputting the current input instance into the machine learning model.

As shown in block 516, the functionality 500 includes generating an output score via the machine learning model in response to the inputting and based on the current input instance.

As shown in block 518, the functionality 500 includes selecting a remedial action to apply within the data center in response to detecting that the output score satisfies a predefined condition.

As shown in block 520, the functionality 500 includes executing the remedial action within the data center. Executing the remedial action within the data center may comprise reconfiguring a scheduler that manages how computing resources found in the one or more computing devices are allocated to jobs in a workload for the data center.

The present disclosure refers to machine-learning models that are stored, trained, and implemented at various network locations. There are many different types of machine-learning models that can be used in the examples described herein, such as convolutional deep neural networks, support vector machines, Bayesian belief networks, association-rule models, decision trees, nearest-neighbor models (e.g., k-NN), regression models, and Q-learning models, among others.

The configurations and parameters for a given type of machine-learning model can vary. For example, the number of hidden layers, the number of hidden nodes in each layer, and the existence of recurrence relationships between layers can in a neural network can be configured in many different ways. Neural networks can be trained using batch gradient descent, stochastic gradient descent, or a combination thereof. Parameters such as the learning rate and momentum are also configurable

Furthermore, individual machine learning models can be combined to form an ensemble machine-learning model. An ensemble machine-learning model may be homogenous (i.e., using multiple member models of the same type) or non-homogenous (i.e., using multiple member models of different types). Individual machine-learning models within an ensemble may all be trained using the same training data or may be trained using overlapping or non-overlapping subsets randomly selected from a larger set of training data. The Random-Forest model, for example, is an ensemble model in which multiple decision trees are generated using randomized subsets of input features and/or randomized subsets of training instances.

While the present technologies may be susceptible to various modifications and alternative forms, the embodiments discussed above have been provided only as examples. It is to be understood that the technologies are not intended to be limited to the particular examples disclosed herein. Indeed, the present technologies include all alternatives, modifications, and equivalents falling within the true spirit and scope of the appended claims.

What is claimed is:

1. A system comprising:
a plurality of computing devices, located in a data center, that are configured to collect telemetry data generated via one or more sensors in the data center;
a first network through which the plurality of computing devices are connected to each other; and
an edge appliance connected to the first network, wherein the edge appliance comprises a processor and memory comprising instructions thereon that, when executed by the processor, cause the processor to perform the following set of actions:
receiving the telemetry data via the first network;
generating training data for a machine-learning model stored at in the memory based on the telemetry data;
training the machine-learning model based on the training data;
receiving, via the first network, additional telemetry data generated via the one or more sensors;
converting the additional telemetry data into a current input instance for the machine learning model;
inputting the current input instance into the machine learning model;
generating an output score via the machine learning model in response to the inputting and based on the current input instance;
selecting a remedial action to apply within the data center in response to detecting that the output score satisfies a predefined condition; and
sending, via the first network, a message that signals at least one of the computing devices to execute the remedial action.

2. The system of claim 1, wherein the edge appliance further comprises a hardware accelerator that performs the training of the machine-learning model.

3. The system of claim 1, wherein the set of actions further comprises:
sending, via a wide area network (WAN), the training data to a cloud computing system that is located outside of the data center.

4. The system of claim 3, wherein the set of actions further comprises:
receiving an updated machine-model from the cloud computing system via the WAN; and
storing the updated machine-learning model in the memory.

5. The system of claim 1, wherein the set of actions further comprises:
transmitting the machine-learning model to a hardware accelerator that is located in a chassis that houses at least one of the plurality of computing devices.

6. The system of claim 1, wherein the telemetry data comprises at least one of:
a central processing unit (CPU) utilization level;
an input/output (I/O) utilization level;
a network utilization level;
sensor data from a temperature sensor; or
sensor data from a voltage sensor.

7. The system of claim 1, wherein executing the remedial action within the data center comprises reconfiguring a scheduler that manages how computing resources found in the plurality of computing devices are allocated to jobs in a workload for the data center.

8. A hardware accelerator comprising:
a processor; and
a memory comprising instructions stored therein that, when executed by the processor, cause the processor to perform a set of actions comprising:
receiving, via a first network, telemetry data generated by one or more sensors in a data center;
generating training data for a machine-learning model stored at the hardware accelerator based on the telemetry data;
training the machine-learning model based on the training data;
receiving, via the first network, additional telemetry data generated via the one or more sensors;
converting the additional telemetry data into a current input instance for the machine learning model;
inputting the current input instance into the machine learning model;
generating an output score via the machine learning model in response to the inputting and based on the current input instance;
selecting a remedial action to apply within the data center in response to detecting that the output score satisfies a predefined condition; and
sending, via the first network, a message that signals at least one computing device in the data center to execute the remedial action.

9. The hardware accelerator of claim 8, wherein the set of actions further comprises:
sending, via the first network, the machine-learning model to an additional hardware accelerator that is located in the at least one computing device.

10. The hardware accelerator of claim 8, wherein the set of actions further comprises:
sending, via a wide area network (WAN), the training data to a cloud computing system that is located outside of the data center.

11. The hardware accelerator of claim 10, wherein the set of actions further comprises:
receiving an updated machine-model from the cloud computing system via the WAN; and
storing the updated machine-learning model in the memory.

12. The hardware accelerator of claim 8, wherein the telemetry data comprises at least one of:
a central processing unit (CPU) utilization level;
an input/output (I/O) utilization level;
a network utilization level;
sensor data from a temperature sensor; or
sensor data from a voltage sensor.

13. A method comprising:
generating, via one or more sensors in a data center, telemetry data at one or more computing devices located in the data center;
transmitting the telemetry data from the one or more computing devices located in the data center to a hardware accelerator located in the data center;
generating training data for a machine-learning model stored at the hardware accelerator based on the telemetry data;
training the machine-learning model based on the training data;
receiving additional telemetry data from the one or more computing devices;
converting the additional telemetry data into a current input instance for the machine learning model;
inputting the current input instance into the machine learning model;
generating an output score via the machine learning model in response to the inputting and based on the current input instance;
selecting a remedial action to apply within the data center in response to detecting that the output score satisfies a predefined condition; and
executing the remedial action within the data center.

14. The method of claim 13, wherein the hardware accelerator is located in an edge appliance that is connected to a data center network (DCN), and wherein the one or more computing devices located in the data center are also connected to the DCN.

15. The method of claim 14, further comprising:
transmitting the machine-learning model to an additional hardware accelerator that is located in a chassis that houses at least one of the one or more computing devices.

16. The method of claim 13, wherein the hardware accelerator is a graphics processing unit (GPU) located in a chassis that houses at least one of the one or more computing devices.

17. The method of claim 13, further comprising transmitting the training data to a cloud computing system that is located outside of the data center.

18. The method of claim 17, further comprising:
receiving an updated machine-model from the cloud computing system; and
storing the updated machine-learning model at the hardware accelerator.

19. The method of claim 13, wherein the telemetry data comprises at least one of:
a central processing unit (CPU) utilization level;
an input/output (I/O) utilization level;
a network utilization level;
sensor data from a temperature sensor; or
sensor data from a voltage sensor.

20. The method of claim 13, wherein executing the remedial action within the data center comprises reconfiguring a scheduler that manages how computing resources found in the one or more computing devices are allocated to jobs in a workload for the data center.
